(19) United States
(12) Patent Application Publication
(10) Pub. No.: US 2010/0287800 A1
(43) Pub. Date: Nov. 18, 2010

(54) TWO SOUND GATEFOLD GREETING CARDS

(76) Inventors: Erik Flesher, Avon, OH (US); Emily Gross, Lakewood, OH (US); David Mayer, Bay Village, OH (US); Eliza DeVogal, Lakewood, OH (US); Katalina Speck, Westlake, OH (US); Sharon Bogdanski, Westlake, OH (US); Allison Marsh, Ravenna, OH (US); Kimberly Bikowski, Avon, OH (US)

Correspondence Address: James C. Scott;Roetzel & Andress, Suite 900, 1375 East Ninth Street, Cleveland, OH, 44114, US

(21) Appl. No.: 12/780,062

(22) Filed: May 14, 2010

Related U.S. Application Data
(60) Provisional application No. 61/178,187, filed on May 14, 2009.

(51) Int. Cl. G09F 1/04

(52) U.S. Cl. 40/124.03

(57) ABSTRACT

A sound-producing greeting card that can play two or more separate and distinct digital audio clips. The greeting card has a gatefold design and includes dual slide activators that trigger the two separate and distinct audio clips. In one embodiment both digital audio clips are pre-recorded digital audio clips that may be music, sound or a verbal messages. In other embodiments, one digital audio clip is pre-recorded and the other can be a personalized consumer recorded message. The greeting card has a push button that activates recording of the personalized message. The greeting cards may additionally contain a mechanism that permanently changes the card from preview mode, wherein a consumer can record a personal message that will automatically be played back and erased, to a permanent mode wherein the consumer recorded message is saved and replayed each time one of the panels of the greeting card is opened.

### RELATED APPLICATIONS

This application claims priority to Provisional U.S. Patent Application No. 61/178,187 filed on May 14, 2009, the entire disclosure of which is incorporated herein by reference.

### FIELD OF THE INVENTION

This disclosure and related inventions relate to greeting cards, and more specifically to sound producing greeting cards.

### BACKGROUND OF THE INVENTION

For many years paper greeting cards have been widely used for sentiment communication and celebratory occasions such as birthdays, graduations, weddings, and for other purposes and occasions. Traditional text information is generally found on paper greeting cards. More recently, sound has been added to traditional paper greeting cards to increase the personalization of cards by delivering an audio message that is electronically embodied in circuitry that is carried within the greeting card. The ability to use sound in combination with printed matter such as with conventional printed greeting cards significantly enhances the communicative value of social and relational greetings. The use of popular music and celebrity voice impersonations has made sound-generating greeting cards increasingly popular.

### SUMMARY OF THE INVENTION

The present disclosure and related inventions advance the personalization of sound producing cards by offering, in one embodiment, two separate pre-recorded audio clips, and in another embodiment, one pre-recorded audio clip and one user-recorded personalized message from the consumer. The cards can be constructed of paper, ink, and an audio module activated by two slide triggers or other sound circuitry activation mechanisms or switches. A first panel of the card is opened and the first audio clip is activated. When a second panel of the card is opened the first audio clip is de-activated and the second audio clip is activated. In other embodiments, multiple sound recordings or sound modules may be separately or collectively activated by the various switches.

In one embodiment, a two-sound gatefold greeting card has a greeting card body having three integral main panels including a left panel, a center panel and a right panel and a fourth panel that is connected to an edge of one of the three integral main panels; a sound module including a speaker, at least one integrated circuit, at least two switch mechanisms, a power source, and at least two pre-recorded digital audio clips saved within the at least one integrated circuit; and the sound module being attached to one of the three integral main panels and concealed therein by the fourth panel, wherein when the left panel is opened, a first of the at least two pre-recorded digital audio clips is activated; and wherein when the right panel is opened, a second of the at least two pre-recorded digital audio clips is activated and the first digital audio clip is deactivated.

In another embodiment, a two-sound greeting card has a greeting card body having three integral main panels including a left panel, a center panel and a right panel and a fourth panel that is connected to an edge of one of the three integral main panels; an electronic module having at least one integrated circuit chip for storing data and controlling the electronic module, at least one speaker, a power source, a press button for recording a personalized audio clip; at least one pre-recorded digital audio clip; a first slide switch mechanism located between the left panel and center panel that controls activation of a first audio clip, and a second slide switch mechanisms located between the center panel and the right panel that controls activation of a second audio clip.

These and other concepts, features and aspects of the disclosure and related inventions are further described herein with reference to the accompanying drawings of representative embodiments.

### DESCRIPTION OF THE DRAWINGS

FIG. 1 is a die cut of a first embodiment of the two-sound greeting card of the present invention.

FIG. 2 is a die cut with sound module of the greeting card of FIG. 1.

FIG. 3 is the front panel of the greeting card of FIG. 1.

FIG. 4 is the right inside panel of the greeting card of FIG. 1.

FIG. 5 is a fully opened greeting card of FIG. 1.

FIG. 6 a die cut drawing of a second embodiment of the two-sound greeting card of the present invention.

FIG. 7 is a die cut of with sound module of the greeting card of FIG. 6.

FIG. 8 is the front cover the greeting card of FIG. 6.

FIG. 9 is the right inside panel of the greeting card of FIG. 6.

FIG. 10 is a drawing of a fully opened greeting card of FIG. 6.

### DETAILED DESCRIPTION OF PREFERRED AND ALTERNATE EMBODIMENTS

The present disclosure and related inventions improve upon and further personalize sound generating greeting cards by offering in a first embodiment, a greeting card that plays at least two separate and distinct pre-recorded digital audio clips, and in a second embodiment, a greeting card that plays at least one pre-recorded digital audio clip and at least one consumer-recordable digital audio message. Both embodiments have a gatefold configuration and include dual slide activators that trigger audio modules attached within or to the greeting card.

The first embodiment of the present disclosure is a greeting card with dual slide activators each triggering an audio module containing two different digital audio clips. The first digital audio clip plays upon opening the first panel of the greeting card and the second digital audio clip plays upon opening the second panel of the greeting card. If the recipient opens the second panel of the card before the first digital audio clip has finished playing, the first audio clip will stop and the second audio clip will begin. The digital audio clips may contain music, a sound, or spoken message. For example, the clips may contain a popular song with vocals, an instrumental music clip, an animal sound such as a cat's meow or a dog barking, a famous movie line, or may alternately contain a joke wherein the first clip is the set-up and the second clip is the punch line.

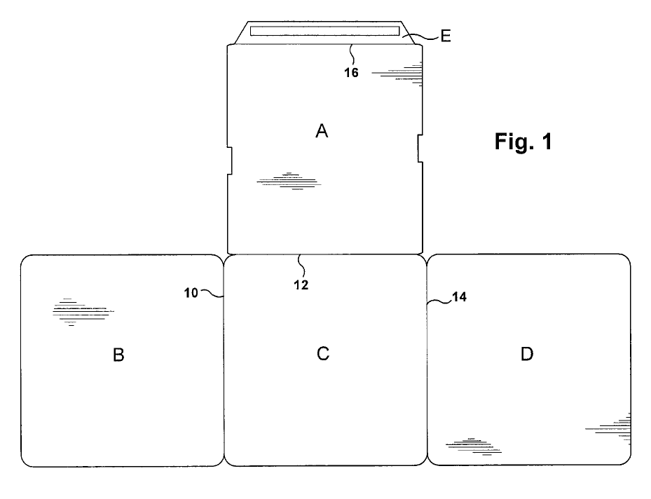

A representative die cut of the first embodiment of the present disclosure is shown in FIG. 1. The greeting card contains four main panels A, B, C, D and one tab panel E. Each panel of the greeting card has a front side and a back side, with the front side of each panel being shown in FIG. 1. Panel B is connected to panel C along fold line 10 and panel C is connected to panel D along fold line 14. Panel A is connected to the top edge of panel C along fold line 12 and panel A is attached to tab panel E along fold line 16. To construct the greeting card, panel A is folded along fold line 12 to lie atop the front side of panel C. Tab panel E is folded along fold line 16 and attached by adhesive or other means, to the backside of panel C. Panel A completely covers the front side of panel C. Panel D is then folded inward along fold line 14 to lie atop panel A and panel B is folded along line 10 to lie atop panel D. The backside of panel B serves as the front cover of the greeting card. When the user opens the greeting card along fold line 10, the front side of panel B becomes the left inside panel of the greeting card and the backside of panel D becomes the right inside panel of the greeting card. When the user further opens the greeting card outward along fold line 14, panel B remains the left inside panel, back side of panel A becomes the middle inside panel, and the front side of panel D becomes the right inside panel of the greeting card.

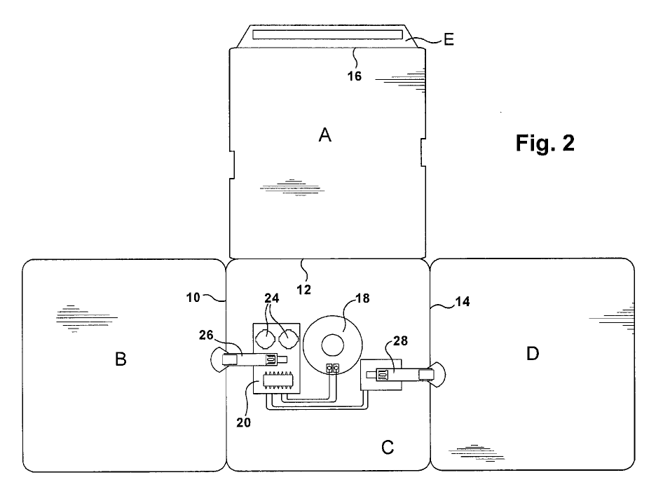

FIG. 2 depicts the die cut of FIG. 1 including attached electronic components, including sound module. These components are attached, by adhesive or other means, to the front side of panel C prior to panel A being attached thereto, thereby concealing the electronic components of the greeting card between panels A and C. The electronic components may include a speaker 18, an integrated circuit board 20, a power source 24, a first slide switch mechanism 26 and a second slide switch mechanism 28. The first slide switch mechanism 26 is located between panels B and C across fold line 10 so that a first switch is closed upon opening the greeting card by unfolding panel B about fold line 10. The second slide switch 28 is located between panels C and D across fold line 14 so that a second switch is closed upon opening the greeting card by unfolding panel D about fold line 14. At least two pre-recorded digital audio clips are stored on a memory device within the integrated circuit board 20. Each pre-recorded digital audio clip may be up to 16 seconds long and both clips may be equal in length or may have differing lengths. For example, the first digital sound clip may be shorter in length than the second sound clip, or vice versa. Also, the first and second sound clips may be equal in length. Each of the at least two pre-recorded audio clips may contain different types of audio, for example, the first clip may be a song or instrumental music clip and the second may be a spoken message, or vice-versa.

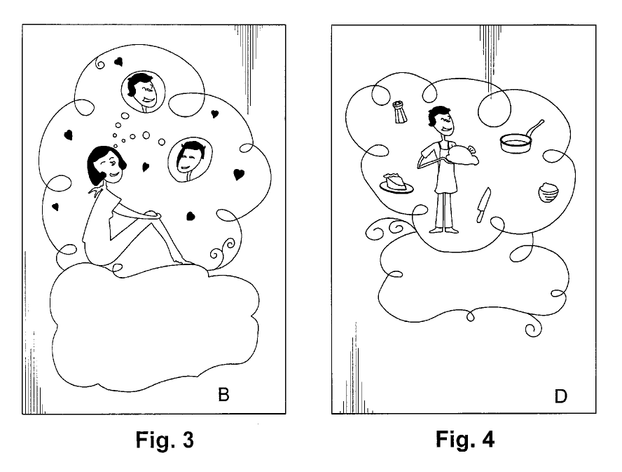

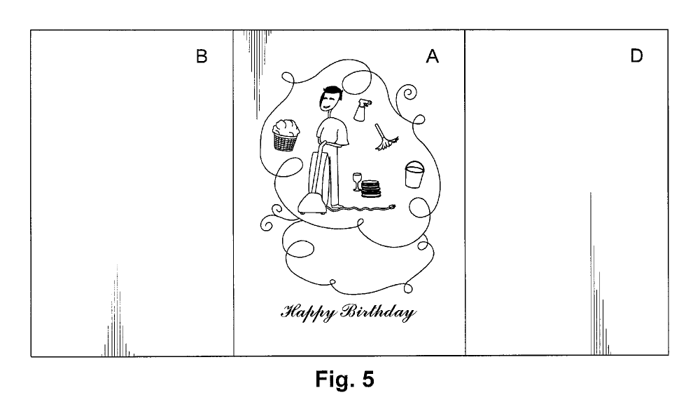

FIG. 3 shows the back side of panel B, which serves as the front cover of the greeting card. When the user opens the greeting card to the left, along fold line 10, it exposes the back side of panel D, which is the inside right panel of the greeting card (shown in FIG. 4). The first slide switch mechanism 26 closes the circuit on the integrated circuit board 20, thus activating a first pre-recorded digital audio clip. When the greeting card is further opened to the right about fold line 14, the second slide switch mechanism 28 closes the circuit on the integrated circuit board 22 thereby activating a second pre-recorded digital audio clip. When the second pre-recorded digital audio clip is activated, the first-pre-recorded digital audio clip is deactivated. With the greeting card fully opened, the front sides of panels B and D and the back side of panel A are exposed, as shown in FIG. 5. These panels are typically decorated with complimentary designs, artwork or text so they are consistent when spread out in three-fold.

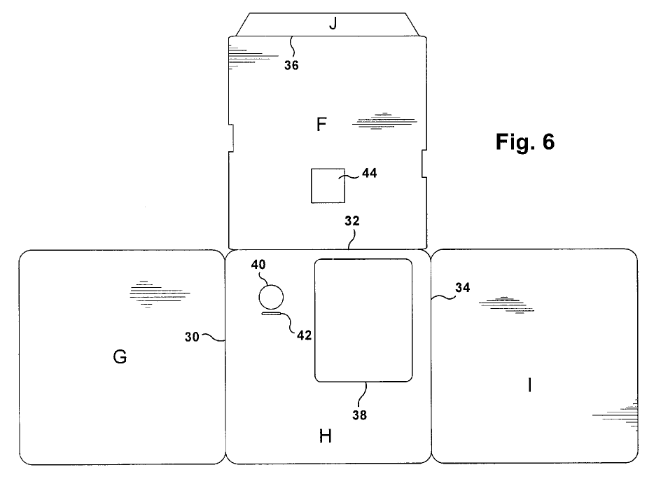

A second embodiment of the present invention and related disclosure is a gatefold greeting card having at least one pre-recorded digital audio clip that is activated upon the opening of one panel of the greeting card, and at least one user-recorded message that is activated upon the opening of a second panel of the greeting card. The die cut of the second embodiment of the present disclosure is depicted in FIG. 6. As with the first embodiment, the greeting card body contains four main panels F, G, H, I and one tab panel J. Each panel has a front side and a back side, with the front sides of each panel being shown in FIG. 6. Panel G is attached to panel H along fold line 30 and panel H is connected to panel I along fold line 34. Panel F is attached to the top edge of panel H along fold line 32 and panel F is attached to tab panel J along fold line 36. To construct the greeting card, panel F is folded downward along fold line 32 to completely cover the front side of panel H. Tab panel J is folded along fold line 36 so that it may be attached, adhesively or otherwise to the back side of panel H. Panel I is then folded along fold line 34 to lie atop the back side of panel F and panel G is folded along fold line 30 to sit atop the back side of panel I. The backside of panel G serves as the front cover of the greeting card and the front side of panel G serves as the right inside panel of the greeting card. When the user opens the greeting card along fold line 30, the front side of panel G becomes the left inside panel of the greeting card and the backside of panel I becomes the right inside panel of the greeting card. When the user further opens the greeting card outward along fold line 34, panel G remains the left inside panel, the back side of panel F becomes the middle inside panel, and the front side of panel I becomes the right inside panel of the greeting card.

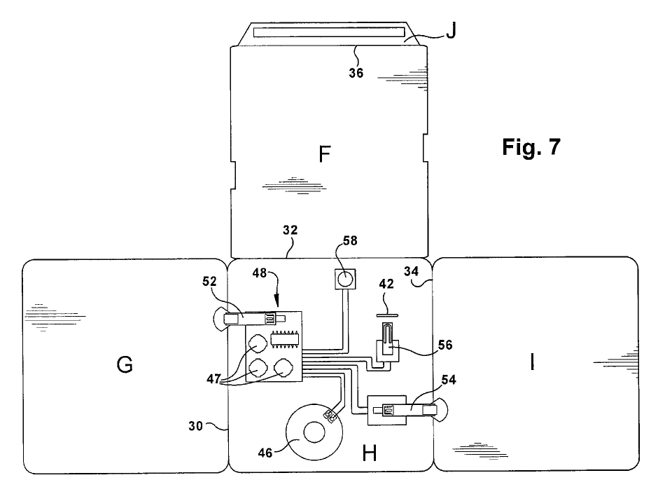

FIG. 7 depicts the die cut of FIG. 6 with an attached sound module. The sound module is attached by adhesive or other means to panel H prior to panel F being attached thereto, thereby concealing the electronic components of the greeting card between panels F and H. The sound module contains a speaker 46, an integrated circuit board 48, a membrane switch 56, a first slide switch mechanism 52, a second slide switch mechanism 54, a power source 47, and a microphone with recording push button 58. A first slide switch mechanism 52 is located between panels G and H across fold line 30 so that when the greeting card is opened about fold line 30, a first pre-recorded digital audio clip is activated. A second slide switch mechanism 54 is placed between panels H and I across fold line 34 so that when the greeting card is further unfolded along fold line 34, a pre-recorded digital audio message is activated.

The sound module is capable of operating in preview mode or permanent mode. Preview mode enables a consumer to test the recording feature of the card at retail without actually recording a message that will be saved. Once the card has been purchased, the card can be changed from preview mode to permanent mode. Permanent mode allows a consumer to record and save a personal message. A pull tab mechanism 40 is located on the back side of panel H that prevents the recording full-length messages until after the card is purchased. The pull tab 40 is attached at one end to a removable sticker, v also located on the back side of panel H, through a slot 42 in panel H to a membrane switch 56 located on the front side of panel H. Prior to the purchase of the greeting card and removal of the pull tab 40, a consumer may preview the sound recording capabilities of the greeting card by unfolding panel I about fold line 34 which will trigger pre-recorded digital audio instructions that instruct the consumer how to record a preview message. After the pre-recorded digital instructions, the consumer may record a preview message by pressing the push button 58, located beneath panel F, and recording a message which will automatically be played back. However, in preview mode, the recording will not be saved. Once the card has been purchased, and the pull tab removed, thereby breaking the membrane switch 56, the user may record a personalized message that is automatically saved and will be replayed upon opening the greeting card by unfolding panel I outward along fold line 34, thereby overwriting the pre-recorded digital recording instructions. A removable sticker is 38 located on the back side of panel H, which also indicates the recording instructions. The entire greeting card or portions thereof may be wrapped in cellophane or other clear cover to prevent consumers from removing the pull tab 40 before purchase. To record a message, the consumer must press and hold the record push button 58, while recording a message. The message will be recorded until the consumer releases the push button 58 or until the maximum record time has elapsed. The maximum record time can be up to approximately 20 seconds in length. The length of the pre-recorded digital audio clip and the personalized recorded message may be the same or may be different. If the consumer recorded audio clip is triggered before the first pre-recorded digital audio clip, the pre-recorded digital audio clip will be deactivated and the consumer recorded audio clip will be played. Of course the pre-recorded digital audio clip and the consumer recorded digital audio clip may be reversed such that the consumer recorded digital audio clip may be played upon closing the first circuit and the pre-recorded digital audio clip may be played upon closing of the second circuit. Also, the user can re-record a message, thereby overwriting the previously saved message, by pressing the record button and recording a new message. This can be done repeatedly until the user is satisfied with the recorded message.

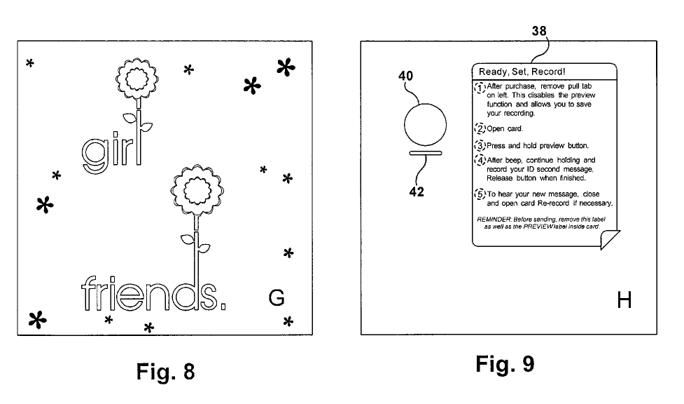

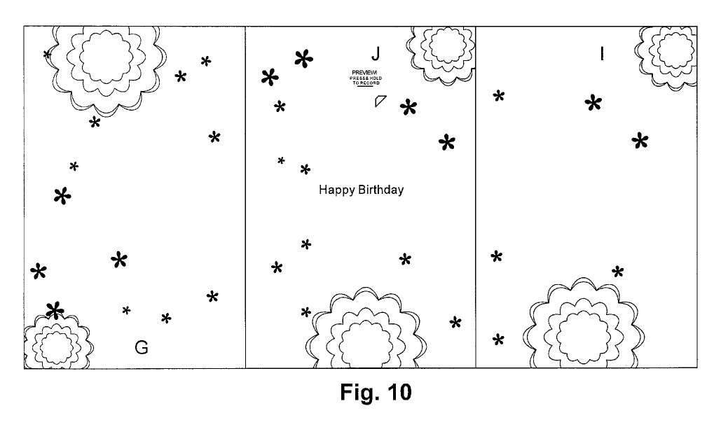

FIG. 8 shows the back side of panel G, which serves as the front of the greeting card. The back side of panel H, which serves as the back of the greeting card, is shown in FIG. 9. With the greeting card fully opened, the front sides of panels G and I and the back side of panel F are exposed, as shown in FIG. 10. These panels are decorated with complimentary designs, artwork or text so they are consistent when spread out in three-fold.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated.

What is claimed is:

1. A multiple sound greeting card comprising:
a greeting card body having three integral main panels including a left panel, a center panel and a right panel and a fourth panel that is connected to an edge of one of the three integral main panels;
a sound module including a speaker, at least one integrated circuit, at least two switch mechanisms, a power source, and at least two pre-recorded digital audio clips saved within the at least one integrated circuit; and
the sound module being attached to one of the three integral main panels and concealed therein by the fourth panel,
wherein when the left panel is opened, a first of the at least two pre-recorded digital audio clips is activated; and
wherein when the right panel is opened, a second of the at least two pre-recorded digital audio clips is activated and the first digital audio clip is deactivated.

2. The multiple sound greeting card of claim 1, wherein the three integral main panels are folded in a gatefold configuration wherein fold lines between the left, center and right panels are generally vertically oriented.

3. The multiple sound greeting card of claim 1, wherein the fourth panel is attached to a tab panel that is used to secure the fourth panel to one of the three integral main panels.

4. The multiple sound greeting card of claim 1, wherein the power source is one or more disposable batteries.

5. The multiple sound greeting card of claim 1, wherein one of the at least two switch mechanisms is placed on a fold line between the left and center panels.

6. The multiple sound greeting card of claim 1, wherein one of the at least two switch mechanisms is placed on a fold line between the center and right panels.

7. The multiple sound greeting card of claim 1, wherein each of the at least two pre-recorded digital audio clips is approximately 16 seconds long.

8. A two-sound greeting card comprising:
a greeting card body having three integral main panels including a left panel, a center panel and a right panel and a fourth panel that is connected to an edge of one of the three integral main panels;
an electronic module having at least one integrated circuit chip for storing data and controlling the electronic module, at least one speaker, a power source, a press button for recording a personalized audio clip;
at least one pre-recorded digital audio clip;
a first slide switch mechanism located between the left panel and center panel that controls activation of a first audio clip;
a second slide switch mechanisms located between the center panel and the right panel that controls activation of a second audio clip.

9. The two-sound greeting card of claim 8, further including means to change to electronic module from first mode to a second mode, wherein in the first mode the second audio clip is a pre-recorded digital audio clip with verbal instructions for how to record a personalized digital audio clip and wherein in the second mode the second audio clip is a personalized digital audio clip.

10. The two-sound greeting card of claim 8, wherein the first audio clip is the at least one pre-recorded digital audio clip and the second audio clip is a personalized digital audio clip.

11. The two-sound greeting card of claim 8, wherein the first audio clip is a personalized digital audio clip and the second audio clip is the at least one pre-recorded digital audio clip.

12. The two-sound greeting card of claim 8, wherein when the second audio clip is activated, the first audio clip is deactivated.

13. A two-sound greeting card comprising:
a greeting card body having a left panel connected to a center panel along a first fold line and the center panel connected to a right panel along a second fold line and a cover panel connected along a third fold line one of the left, center or right panels;
an electronic module with at least one integrated circuit chip for storing data and controlling the electronic module;
at least one pre-recorded digital audio clip;
a press button for recording a personalized digital audio clip;
a first switch mechanism for controlling activation of the at least one pre-recorded digital audio clip;
a second switch mechanism for controlling activation of the personalized digital audio clip;
means for switching the electronic module from a first mode to a second mode;
in the first mode, the personalized digital audio recording is immediately played back but is not saved;
in a second mode, the personalized digital audio recording is saved.

14. The two-sound recordable greeting card of claim 13, wherein the first and second switch mechanisms are slide switch mechanisms.

15. The two-sound recordable greeting card of claim 14, wherein the first switch mechanism is located over the first fold line between the left and center panels.

16. The two-sound recordable greeting card of claim 14, wherein the second switch mechanism is located over the second fold line between the center and right panels.

17. The two-sound recordable greeting card of claim 13, wherein when the personalized digital audio clip is activated, the at least one pre-recorded digital audio clip is deactivated.

18. The two-sound recordable greeting card of claim 13, wherein the personalized digital audio clip is approximately between 10 and 20 seconds in length.

19. The two-sound recordable greeting card of claim 13, wherein the at least one pre-recorded digital audio clip is approximately between 16 and 26 seconds in length.

20. The two-sound recordable greeting card of claim 13, wherein the sound module is completely concealed between two panels of the greeting card.
